(19) United States
(12) Patent Application Publication
(10) Pub. No.: US 2026/0071931 A1
(43) Pub. Date: Mar. 12, 2026

(54) CONTINUOUS EMISSION LEVEL MONITORING AND DETECTION USING UNMANNED AERIAL VEHICLES

(71) Applicant: Honeywell International Inc., Charlotte, NC (US)

(72) Inventors: Rajapriyan Thambidurai, Bangalore (IN); Sridhar Sankaranarayanan, Bangalore (IN); Sandhya Beejady, Bengaluru (IN)

(21) Appl. No.: 19/042,289

(22) Filed: Jan. 31, 2025

(30) Foreign Application Priority Data
Sep. 6, 2024 (IN) 202411067580

(51) Int. Cl. G01M 3/04

(52) U.S. Cl. CPC G01M 3/04

(57) ABSTRACT

Continuous emission level monitoring and detection using unmanned aerial vehicles is described herein. One embodiment includes capturing, by a plurality of sensors located at a site, emission levels at the site, receiving, by a computing device, the captured emission levels from the plurality of sensors, determining, by the computing device based on the emission levels received from the plurality of sensors, whether to trigger an unmanned aerial vehicle (UAV) to fly to a location at the site to detect whether an emission level at the location exceeds a pre-determined threshold, and triggering, by the computing device responsive to a result of the determination, the UAV to fly to the location at the site to detect whether an emission level at the location exceeds the pre-determined threshold.

### PRIORITY INFORMATION

This application claims priority pursuant to 35 U.S.C. § 119(a) to India Patent Application No. 202411067580, the contents of which are incorporated herein by reference.

### TECHNICAL FIELD

The present disclosure relates generally to devices, methods, and systems for continuous emission level monitoring and detection using unmanned aerial vehicles.

### BACKGROUND

During operations at sites such as industrial sites, manufacturing sites, agricultural sites, mining sites, etc., emissions of various substances, such as, for instance, gas leaks, may occur. In some instances, such an emission may indicate a problem is occurring at the site. However, detecting, locating, verifying, and/or controlling such emissions can be difficult, time consuming, and/or dangerous due to, for instance, the size, remoteness, and/or complexity of the site, among other factors. For instance, in previous approaches, an engineer, technician, field operator, or other personnel must manually coordinate the detection, location, verification, and control of such emissions by, for instance, sending someone to a potential leak location and/or manually scheduling an unmanned aerial vehicle to conduct a site-level emission survey.

### BRIEF DESCRIPTION OF THE DRAWINGS

FIG. 1 illustrates a block diagram of an example of a system for continuous emission level monitoring and detection using unmanned aerial vehicles in accordance with one or more embodiments of the present disclosure.

FIG. 2 illustrates an example of a method for continuous emission level monitoring and detection using unmanned aerial vehicles in accordance with one or more embodiments of the present disclosure.

FIG. 3 is a block diagram of an example of a computing device for continuous emission level monitoring and detecting using unmanned aerial vehicles in accordance with one or more embodiments of the present disclosure.

FIG. 4 is a block diagram of an unmanned aerial vehicle (UAV) for continuous emission level monitoring and detection in accordance with one or more embodiments of the present disclosure.

FIG. 5 illustrates a route for a UAV to take to travel to a location at a site for continuous emission level monitoring and detection in accordance with one or more embodiments of the present disclosure.

### DETAILED DESCRIPTION

Continuous emission level monitoring and detection using unmanned aerial vehicles is described herein. One embodiment includes capturing, by a plurality of sensors located at a site, emission levels at the site, receiving, by a computing device, the captured emission levels from the plurality of sensors, determining, by the computing device based on the emission levels received from the plurality of sensors, whether to trigger an unmanned aerial vehicle (UAV) to fly to a location at the site to detect whether an emission level at the location exceeds a pre-determined threshold, and triggering, by the computing device responsive to a result of the determination, the UAV to fly to the location at the site to detect whether an emission level at the location exceeds the pre-determined threshold.

The present disclosure includes a machine learning approach that can utilize a sniffer algorithm to continuously monitor emission levels (e.g., gas emission levels) at a site (e.g., an industrial site, a manufacturing site, an agricultural site, a mining site, etc.) to determine whether the emission levels exceed a pre-determined threshold, which in turn can indicate a potential gas leak or other problem may be occurring at the site, and automatically determine when an unmanned aerial vehicle (UAV) flight should be triggered to fly to the location of a potential gas leak or problem to detect whether an emission level at the location exceeds the pre-determined threshold (e.g., to verify the leak or other problem is occurring). Such an approach can be quicker, safer, and more effective in detecting, locating, verifying, and controlling gas leaks or other problems at the site than previous approaches in which an engineer, technician, field operator, and/or other personnel must manually coordinate the detection, location, verification, and control of the leak by, for instance, manually scheduling a UAV for a site-level emission survey (e.g., a survey of a large portion of the site or the entire site) and/or sending someone to a potential leak location, which may time consuming and/or may expose human personnel to hazardous and/or remote locations. As such, embodiments of the present disclosure may allow for quicker, safer, and more effective resolution of gas leaks or other problems occurring at the facility, thereby avoiding potential monetary and/or environmental damages.

As an example, a plurality of sensors located throughout the site can continuously capture gas emission levels at their respective site locations, and continuously send these captured emission levels to a computing device. The computing device can continuously monitor these received emission levels to determine whether to trigger a UAV (e.g. a drone) to fly to a location at the site to detect whether an emission level at that specific location exceeds a pre-determined threshold. For instance, if the computing device determines that an emission level at a site location exceeds the pre-determined threshold based on the emission levels received from the sensor(s) at that location, the computing device can trigger a UAV to fly to that specific location to detect whether an emission level at that location exceeds the pre-determined threshold. In some examples, the computing device may first determine that safety pre-requisites for the UAV to fly to the location are met, and then trigger the UAV flight responsive to determining those safety pre-requisites are met. Further, the computing device can receive notifications of operations occurring at the site, and take these operations into account when determining whether to trigger the UAV flight. The computing device can determine the route for the UAV to take to fly to the location based on, for instance, the layout of the site and the location of the sensor(s).

Once the UAV has flown to the location, the UAV can detect whether an emission level at the location exceeds the pre-determined threshold (e.g., to verify whether a leak is actually occurring at that location). For instance, the UAV can include a sensor that can be used to detect whether an emission level at the location exceeds the pre-determined threshold. If the UAV detects that an emission level at the location exceeds the pre-determined threshold, the UAV can send a notification to the computing device. Responsive to receiving the notification, the computing device can trigger an operation to reduce the emission level at the location (e.g., to fix the leak or other problem).

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that mechanical, electrical, and/or process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

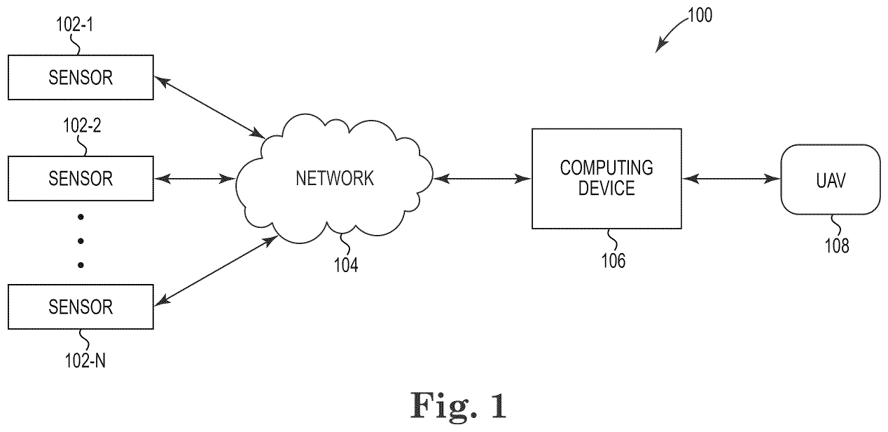

The figures herein follow a numbering convention in which the first digit or digits correspond to the drawing figure number and the remaining digits identify an element or component in the drawing. Similar elements or components between different figures may be identified by the use of similar digits. For example, 108 may reference element “08” in FIG. 1, and a similar element may be referenced as 408 in FIG. 4.

As used herein, “a”, “an”, or “a number of” something can refer to one or more such things, while “a plurality of” something can refer to more than one such things. For example, “a number of components” can refer to one or more components, while “a plurality of components” can refer to more than one component. Additionally, the designator “N”, as used herein, particularly with respect to reference numerals in the drawings, indicates that a number of the particular feature so designated can be included with a number of embodiments of the present disclosure.

FIG. 1 illustrates a block diagram of an example of a system 100 for continuous emission level monitoring and detection using unmanned aerial vehicles in accordance with one or more embodiments of the present disclosure. The system 100 can include a plurality of sensors 102-1, 102-2, . . . , 102-N (which may be collectively referred to herein as sensors 102), a computing device 106, and an unmanned aerial vehicle (UAV) 108, as illustrated in FIG. 1.

Sensors 102 can be located at a site. For instance, each respective sensor 102-1, 102-2, . . . , 102-N can be located at a different location at the site (e.g., sensor 102-1 can be located at a first location at the site, sensor 102-2 can be located at a second location at the site, etc.).

The site can be, for example, an industrial site, a manufacturing site, an agricultural site, or a mining site. Further, the site may be a large site, a remotely located site, and/or a complex site. For instance, the site can be a petroleum (e.g., oil) refinery. As an additional example, the site can be a route along which a pipeline travels. As an additional example, the site can be an industrial plant. As an additional example, the site can be a farm and/or ranch. Embodiments of the present disclosure, however, are not limited to a particular type of site.

Sensors 102 can each be the same type of sensor, or sensors 102 can include different types of sensors. For instance, sensor 102-1 can be a first type of sensor, sensor 102-2 can be a second type of sensor, etc. As an example, sensors 102 can include one or more gas detectors. As an additional example, sensors 102 can include one or more imaging cameras, such as gas cloud imaging cameras, thermal imaging cameras, and/or infrared imaging cameras. Sensors 102 may utilize wide area network (WAN) communication protocols, such as, for instance, long range (LoRa) WAN communication protocols to allow for communication coverage across a large area of the site and/or large sites. Embodiments of the present disclosure, however, are not limited to a particular type of sensor(s) or combination of sensors.

Sensors 102 can continuously capture (e.g., continuously measure) emission levels at the site. For instance, each respective sensor 102-1, 102-2, . . . , 102-N can continuously capture emission levels at is respective location at the site (e.g., sensor 102-1 can capture emission levels at the first location at the site, sensor 102-2 can capture emission levels at the second location at the site, etc.). The emission levels captured by sensors 102 can include, for example, gas emission levels at the respective locations of the sensors, such as, for instance, levels of carbon dioxide, methane, biomethane, nitrous oxide, natural gas, poisonous gas (e.g., benzine), or smoke present in the air at the respective sensor locations. As an additional example, the emission levels captured by sensors 102 can include water quality levels, such as levels of biochemical oxygen demand and/or chemical oxygen demand levels present in water (e.g., wastewater) at the respective sensor locations. Embodiments of the present disclosure, however, are not limited to these examples.

As shown in FIG. 1, sensors 102 can communicate with computing device 106 via a network 104. For example, sensors 102 can continuously send (e.g., transmit and/or upload) their respective captured emission levels (e.g., sensor 102-1 can send its captured emission levels, sensor 102-2 can send its captured emission levels, etc.) to computing device 106, and computing device 106 can continuously receive the captured emission levels from sensors 102, via network 104.

Sensors 102 can also send their respective locations (e.g., information indicating their respective locations) at the site (e.g., sensor 102-1 can send its location at the site, sensor 102-2 can send its location at the site, etc.) to computing device 106, and computing device 106 can receive the location of each respective sensor 102 at the site from the sensors, via network 104. The locations of the sensors can indicate (e.g., correspond to) the locations at the site at which the respective emission levels are captured.

Sensors 102 can also send the times they captured their respective emission levels (e.g., sensor 102-1 can send the times it captured its emission levels, sensor 102-2 can send the times it captured its emission levels, etc.) to computing device 106, and computing device 106 can receive the times that each respective sensor 102 captured their respective emission levels, via network 104. The times can indicate (e.g., correspond to) when the respective emission levels were captured at the site.

Sensors 102 can also send the type (e.g., information indicating the type) of their respective captured emission levels (e.g., sensor 102-1 can send the type of emission level it captures, sensor 102-2 can send the type of emission level it captures, etc.) to computing device 106, and computing device 106 can receive the type of emission levels captured by each respective sensor 102 from the sensors, via network 104. The type of emission level can indicate, for instance, the type of gas or water quality level captured by each respective sensor, examples of which are previously described herein.

Network 104 can be a network relationship through which sensors 102 and computing device 106 can communicate. Examples of such a network relationship can include a distributed computing environment (e.g., a cloud computing environment), a wide area network (WAN) such as the Internet or a LoRaWAN, a local area network (LAN), a personal area network (PAN), a campus area network (CAN), or metropolitan area network (MAN), among other types of network relationships. For instance, network 104 can include a number of servers that receive information from, and transmit information to, sensors 102 and computing device 106 via a wired or wireless network.

As used herein, a “network” can provide a communication system that directly or indirectly links two or more computers and/or peripheral devices and allows users to access resources on other computing devices and exchange messages with other users. A network can allow users to share resources on their own systems with other network users and to access information on centrally located systems or on systems that are located at remote locations. For example, a network can tie a number of computing devices, such as computing device 106, together to form a distributed control network (e.g., cloud).

A network may provide connections to the Internet and/or to the networks of other entities (e.g., organizations, institutions, etc.). Users may interact with network-enabled software applications to make a network request, such as to get a file or print on a network printer. Applications may also communicate with network management software, which can interact with network hardware to transmit information between devices on the network.

Based on the captured emission levels received from sensors 102, computing device 106 can continuously determine whether to trigger UAV 108 to fly to a location at the site (e.g., to any of the different respective locations at the site at which the sensors 102 are located) to detect whether an emission level at that location exceeds a pre-determined (e.g., pre-defined) threshold. Responsive to a result of the determination, computing device 106 can trigger UAV 108 to fly to that location at the site to detect whether an emission level at that location exceeds the pre-determined threshold. UAV 108 can be, for example, a drone, and will be further described herein (e.g., in connection with FIG. 4).

As an example, if computing device 106 determines that a captured emission level received from one of the sensors 102 meets or exceeds the pre-determined threshold, this can be an indication that a potential gas leak or other problem may be occurring at the location at the site where that sensor is located. Accordingly, responsive to determining the emission level received from that sensor exceeds the pre-determined threshold, computing device 106 can trigger UAV 108 to fly to that location at the site to detect whether an emission level at that location exceeds the pre-determined threshold (e.g., to verify a gas leak or other problem is actually occurring at that location). Computing device 106 can determine the location for UAV 108 to fly to (e.g., the location of the site where the gas leak or other problem may be occurring) based on the location of the sensor. For instance, if a captured emission level received from sensor 102-1 meets or exceeds the pre-determined threshold, computing device 106 can trigger UAV 108 to fly to the location at the site where sensor 102-1 is located to detect whether an emission level at that location exceeds the pre-determined threshold; if a captured emission level received from sensor 102-2 meets or exceeds the pre-determined threshold, computing device 106 can trigger UAV 108 to fly to the location at the site where sensor 102-2 is located to detect whether an emission level at that location exceeds the pre-determined threshold, etc.

Computing device 106 can trigger UAV 108 to fly to a location at the site to detect whether an emission level at that location exceeds the pre-determined threshold by, for instance, sending (e.g., transmitting) a command to UAV 108. Computing device 106 can send the command to UAV 108 via a wired or wireless network, such as, for instance, network 104 or a different network (not shown in FIG. 1 for simplicity and so as not to obscure embodiments of the present disclosure) through which computing device 106 and UAV 108 can communicate.

In some embodiments, computing device 106 can, prior to triggering UAV 108 to fly to a location at the site, determine whether safety pre-requisites for the UAV to fly to that location are met. In such embodiments, computing device 106 may trigger UAV 108 to fly to the location at the site responsive to determining the safety pre-requisites are met (e.g., computing device 106 may refrain from triggering UAV 108 to fly to the location if the safety pre-requisites are not met, even if the captured emission level received from the sensor at that location exceeds the pre-defined threshold).

In some embodiments, computing device 106 can receive notifications of operations (e.g., operational events) occurring at the site (e.g., at different locations at the site). In such embodiments, computing device 106 can determine whether to trigger UAV 108 to fly to a location at the site based on the operations occurring at the site (e.g., computing device 106 can take the operations occurring at the site into account when determining whether to trigger the UAV). For instance, if an operation (e.g., an intentional and/or scheduled operation) is occurring at the site that may cause an emission level at a location at the site to exceed the pre-determined threshold, computing device 106 can receive a notification that this operation is occurring and refrain from triggering UAV 108 from flying to that location if the emission level at the location is exceeding the pre-determined threshold while the operation is occurring, because in such a situation it would be the operation (e.g., and not a gas leak or other problem) that is causing the emission level to exceed the threshold. Such an operation can be, for instance, a scheduled gas release, a heating operation, or a cooling operation, among others.

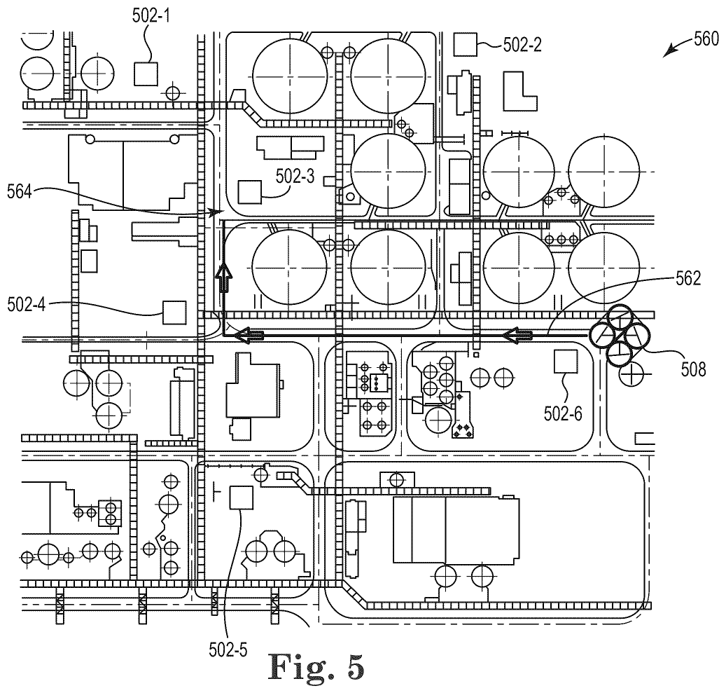

In some embodiments, computing device 106 can determine the route for UAV 108 to take to fly to the location at the site. For instance, computing device 106 can include (e.g., store) a layout of the site, and can determine the route for UAV 108 to take based on the layout of the site and the location of the sensor 102 that captured the emission level exceeding the pre-determined threshold. Computing device 106 can send the determined route to UAV 108 with the command to trigger the flight, for instance. An example illustrating the determination of such a route will be further described herein (e.g., in connection with FIG. 5).

Although one UAV 108 is shown in the example illustrated in FIG. 1, embodiments of the present disclosure are not so limited, and can include a plurality of UAVs analogous to UAV 108 that can be triggered to fly to a location at the site to detect whether an emission level at that location exceeds the pre-determined threshold. For instance, in some embodiments, system 100 can include different types of UAVs. In such embodiments, computing device 106 can select which type of UAV to trigger to fly to the location at the site based on the location of the sensor 102 that captured the emission level exceeding the pre-determined threshold and/or the determined route for the UAV to take to the location (e.g., computing device can select a type of UAV capable of flying to the location and detecting the emission level at the location). For instance, the type of UAV to trigger to fly to the location can be selected based on the climate of the location, the distance of the route, the type of emission at the location, etc.

In some embodiments, computing device 106 can determine whether to trigger UAV 108 to fly to a location at the site based on results of previous detections by UAV 108 (or another UAV) of whether an emission level at that location exceeds the pre-determined threshold (e.g., computing device 106 can take the results of the previous UAV detections into account when determining whether to trigger the UAV). For instance, if previous detections by UAV 108 have indicated that previous emission levels at the location have not actually exceeded the pre-determined threshold even though the sensor at that location was previously capturing emission levels exceeding the threshold, computing device 106 may refrain from triggering UAV 108 to fly to the location even though the sensor at that location has currently captured an emission level exceeding the threshold, because the results of the previous detections indicate that the emission level at the location is likely not actually exceeding the threshold (e.g. the emission level captured by the sensor is likely a false alarm).

Responsive to being triggered to fly to a location at the site to detect whether an emission level at that location exceeds the pre-determined threshold, UAV 108 can fly to that location at the site and detect, upon arriving at the location at the site, whether an emission level at that location exceeds the pre-determined threshold. For example, UAV 108 can include a sensor that can detect the emission level at the location, as will be further described herein (e.g., in connection with FIG. 4).

UAV 108 can send a notification (e.g., alert) to computing device 106 indicating the result of the detection. For example, if UAV 108 detects that the emission level at the location exceeds the pre-determined threshold, UAV 108 can send a notification to computing device 106 verifying that the emission level at the location exceeds the pre-determined threshold (e.g., an alert verifying that a gas leak or other problem is actually occurring at the location). If, however, UAV 108 detects that the emission level at the location does not exceed the pre-determined threshold, UAV 108 can send a notification to computing device 106 that the emission level at the location does not exceed the pre-determined threshold (e.g., an alert that a gas leak or other problem is not actually occurring). UAV 108 can send the notification to computing device 106 via the same network through which computing device 106 sends the command to fly to the location to UAV 108.

Responsive to receiving a notification verifying that the emission level at the location exceeds the pre-determined threshold, computing device 106 can automatically trigger an operation to reduce the emission level (e.g., to fix the leak or other problem) at that location. For example, computing device 106 can determine (e.g., search for and find) the console of the personnel (e.g., engineer, technician, field operator, and/or other personnel) responsible for operations at that location, and schedule a work order to fix the leak or other problem.

Further, in some embodiments, computing device 106 can determine whether to trigger UAV 108 to fly to an additional location at the site to detect whether an emission level at that location exceeds the pre-determined threshold based on the notification (e.g., responsive to receiving the verification of the gas leak or other problem). For instance, computing device 106 may trigger UAV 108 to fly to the additional location to detect whether the emission level at that location exceeds the pre-determined threshold in order to determine the full extent of the leak or other problem (e.g., the full area of the site affected by the leak or other problem). Computing device can trigger UAV 108 to fly to the additional location to detect whether the emission level at that location exceeds the pre-determined threshold in a manner analogous to that previously described herein.

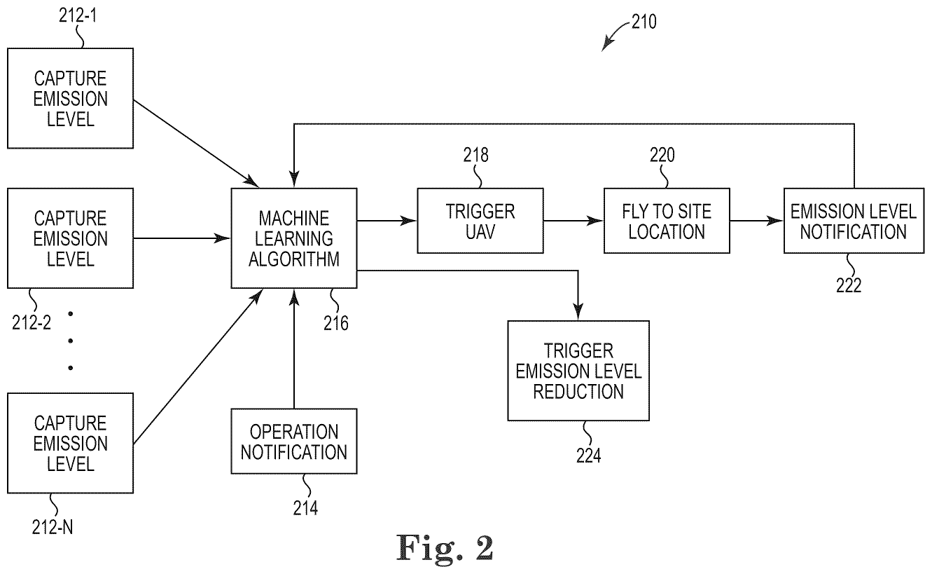

FIG. 2 illustrates an example of a method 210 for continuous emission level monitoring and detection using unmanned aerial vehicles in accordance with one or more embodiments of the present disclosure.

At block 212-1, an emission level is captured at a first location at a site. At block 212-2, an emission level is captured at a second location at the site. At block 212-N, an emission level is captured at an Nth location at the site. The site can be, for instance, an industrial site, a manufacturing site, an agricultural site, or a mining site, and may be a large site, a remotely located site, and/or a complex site, as previously described herein (e.g., in connection with FIG. 1).

The emission levels can be continuously captured by sensors at the respective locations of the site. For instance, the emission level at the first location can be captured by sensor 102-1 previously described in connection with FIG. 1, the emission level at the second location can be captured by sensor 102-2 previously described in connection with FIG. 1, and the emission level at the Nth location can be captured by sensor 102-N previously described in connection with FIG. 1.

The emission levels captured at blocks 212-1, 212-2,. 212-N can be the same type of emission level, or different types of emission levels. For example, the emission level captured at block 212-1 can be a first type of emission level, the emission level captured at block 212-2 can be a second type of emission level, etc. The type(s) of emission levels can include, for example, gas emission levels and/or water quality levels, as previously described herein (e.g., in connection with FIG. 1).

As shown in FIG. 2, the emission levels captured at blocks 212-1, 212-2, . . . , 212-N can be input into a machine learning algorithm 216. Machine learning algorithm 216 can be, for example, a sniffer algorithm, and can be included in computing device 106 previously described in connection with FIG. 1.

Based on the captured emission levels, machine learning algorithm 216 can continuously determine whether to trigger a UAV (e.g. drone) to fly to a location at the site (e.g., to any of the different respective locations at the site at which the emission levels were captured) to detect whether an emission level at that location exceeds a pre-determined (e.g., pre-defined) threshold. Responsive to a result of the determination, machine learning algorithm 216 can trigger the UAV at block 218 to fly to that location at the site to detect whether an emission level at that location exceeds the pre-determined threshold. The UAV can be, for instance, UAV 108 previously described in connection with FIG. 1.

As an example, if machine learning algorithm 216 determines that a captured emission level meets or exceeds the pre-determined threshold, this can be an indication that a potential gas leak or other problem may be occurring at the location at the site where that emission level was captured. Accordingly, responsive to determining the emission level exceeds the pre-determined threshold, machine learning algorithm 216 can trigger the UAV at block 218 to fly to the location at the site where that emission level was captured to detect whether an emission level at that location exceeds the pre-determined threshold (e.g., to verify a gas leak or other problem is actually occurring at that location). For instance, if the emission level captured at block 212-1 meets or exceeds the pre-determined threshold, machine learning algorithm 216 can trigger the UAV at block 218 to fly to the location at the site where that emission level was captured to detect whether an emission level at that location exceeds the pre-determined threshold; if the emission level captured at block 212-2 meets or exceeds the pre-determined threshold, machine learning algorithm 216 can trigger the UAV at block 218 to fly to the location at the site where that emission level was captured to detect whether an emission level at that location exceeds the pre-determined threshold, etc. Machine learning algorithm 216 can trigger the UAV at block 218 to fly to the location at the site by, for instance, sending a command to the UAV, as previously described herein (e.g., in connection with FIG. 1).

The pre-determined threshold can correspond to (e.g., depend on) the type of emission level that is captured. For instance, if the captured emission level is a methane level, the pre-determined threshold can be a pre-determined methane level; if the captured emission level carbon dioxide level, the pre-determined threshold can be a pre-determined carbon dioxide level. Machine learning algorithm 216 can include any number of pre-determined thresholds corresponding to any number of different types of emission levels.

As shown in FIG. 2, notifications of operations (e.g., operational events) occurring at the site (e.g., at different locations of the site) can be input into machine learning algorithm 216 at block 214.

Machine learning algorithm 216 can determine whether to trigger the UAV at block 218 to fly to a location at the site based on the operations occurring at the site (e.g., machine learning algorithm 216 can take the operations occurring at the site into account when determining whether to trigger the UAV). For instance, if an operation (e.g., an intentional and/or scheduled operation) is occurring at the site that may cause an emission level at a location at the site to exceed the pre-determined threshold, machine learning algorithm 216 can receive a notification that this operation is occurring and refrain from triggering a UAV from flying to that location if the emission level at the location is exceeding the pre-determined threshold while the operation is occurring, because in such a situation it would be the operation (e.g., and not a gas leak or other problem) that is causing the emission level to exceed the threshold. Such an operation can be, for instance, a scheduled gas release, a heating operation, or a cooling operation, among others.

Further, although not shown in FIG. 2 for simplicity and so as not to obscure embodiments of the present disclosure, machine learning algorithm 216 can, prior to triggering the UAV at block 218 to fly to the location at the site, determine whether safety pre-requisites for the UAV to fly to that location are met, as previously described herein (e.g., in connection with FIG. 1). Further, machine learning algorithm 216 can determine the route for the UAV to take to fly to the location at the site, and send the determined route to the UAV when triggering the flight, as previously described herein (e.g., in connection with FIG. 1). Further, machine learning algorithm 216 can determine whether to trigger the UAV to fly to the location based on the results of a previous UAV detection(s) of whether an emission level at that location exceeds the pre-determined threshold, as previously described herein (e.g., in connection with FIG. 1).

Responsive to being triggered to fly to a location at the site to detect whether an emission level at that location exceeds the pre-determined threshold, the UAV can fly at block 220 to that location at the site and detect, upon arriving at the location at the site, whether an emission level at that location exceeds the pre-determined threshold. For example, the UAV can include a sensor that can detect the emission level at the location, as will be further described herein (e.g., in connection with FIG. 4).

At block 222, the UAV can send a notification (e.g., alert) to machine learning algorithm 216 indicating the result of the detection, in a manner analogous to that previously described herein (e.g., in connection with FIG. 1). Responsive to receiving a notification indicating the detection verified that the emission level at the location exceeds the pre-determined threshold, machine learning algorithm 216 can automatically trigger an operation to reduce the emission level (e.g., to fix the leak or other problem) at that location. For example, machine learning algorithm 216 can determine the console of the personnel responsible for operations at that location, and schedule a work order to fix the leak or other problem, as previously described herein (e.g., in connection with FIG. 1). Further, although not shown in FIG. 2, machine learning algorithm 216 can determine whether to trigger the UAV to fly to an additional location at the site to detect whether an emission level at that location exceeds the pre-determined threshold, in a manner analogous to that previously described herein (e.g., in connection with FIG. 2).

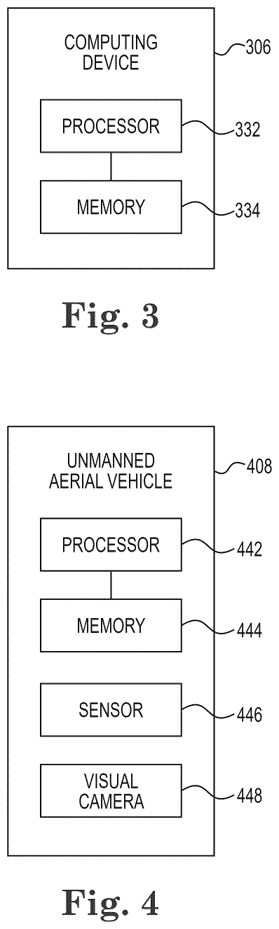

FIG. 3 is a block diagram of an example of a computing device 306 for continuous emission level monitoring and detection using unmanned aerial vehicles in accordance with one or more embodiments of the present disclosure. Computing device 306 can be, for example, computing device 106 previously described in connection with FIG. 1. As illustrated in FIG. 3, the computing device 306 can include a memory 334 and a processor 332 for continuous emission level monitoring and detection using unmanned aerial vehicles, in accordance with the present disclosure.

The memory 334 can be any type of storage medium that can be accessed by the processor 332 to perform various examples of the present disclosure. For example, the memory 334 can be a non-transitory computer readable medium having computer readable instructions (e.g., executable instructions/computer program instructions), such as, for instance, machine learning algorithm 216 previously described in connection with FIG. 2, stored thereon that are executable by the processor 332 for continuous emission level monitoring and detection using unmanned aerial vehicles in accordance with the present disclosure.

The memory 334 can be volatile or nonvolatile memory. The memory 334 can also be removable (e.g., portable) memory, or non-removable (e.g., internal) memory. For example, the memory 334 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 334 is illustrated as being located within computing device 306, embodiments of the present disclosure are not so limited. For example, memory 334 can also be located internal to another computing resource (e.g., enabling computer readable instructions to be downloaded over the Internet or another wired or wireless connection).

The processor 332 may be a central processing unit (CPU), a semiconductor-based microprocessor, and/or other hardware devices suitable for retrieval and execution of machine-readable instructions stored in memory 334.

FIG. 4 is a block diagram of an unmanned aerial vehicle (UAV) 408 for continuous emission level monitoring and detection in accordance with one or more embodiments of the present disclosure. UAV 408 can be, for example, UAV 108 previously described in connection with FIG. 1.

As used herein, a UAV (e.g., UAV 408) can refer to an aircraft that does not have a human pilot or operator on board, and whose flight is controlled autonomously by an on-board computing system and/or by a human or computer via remote control. For example, UAV 408 can be a drone. UAV 408 can use aerodynamic forces, for example, to provide lift, and can be capable of travelling (e.g., flying) to remote locations that may otherwise be difficult and/or dangerous to reach.

As shown in FIG. 4, UAV 408 includes a memory 444 and a processor 442 coupled to memory 444. The memory 444 can be any type of storage medium that can be accessed by the processor 442 to perform various examples of the present disclosure. For example, the memory 444 can be a non-transitory computer readable medium having computer readable instructions (e.g., executable instructions/computer program instructions), stored thereon that are executable by the processor 442 for continuous emission level monitoring and detection in accordance with the present disclosure. For example, UAV 408 can be triggered to fly to a location at a site to detect whether an emission level at that location exceeds a pre-determined threshold, as previously described herein.

The memory 444 can be volatile or non-volatile memory, in a manner analogous to memory 334 previously described in connection with FIG. 3. Further, processor 442 may be a CPU, a semiconductor-based microprocessor, and/or other hardware devices suitable for retrieval and execution of machine-readable instructions stored in memory 444, in a manner analogous to processor 432 previously described in connection with FIG. 3.

As shown in FIG. 4, UAV 408 can include a sensor 446. Sensor 446 can be used by UAV 408 to detect the emission level at the location at the site (e.g., whether the emission level at that location exceeds a pre-determined threshold) upon arriving at the location, as previously described herein. For example, sensor 446 can be a gas cloud imaging camera, a thermal imaging camera, or an infrared imaging camera. In some examples, sensor 446 can be a different type of sensor than sensors 102-1, 102-2, . . . , 102-N previously described in connection with FIG. 1.

As shown in FIG. 4, UAV 408 can include a visual camera 448. Visual camera 448 can capture visual images and/or video of the location at the site while detecting the emission level at that location. Visual camera 448 can also capture visual images and/or video of the site while travelling to and/or from the location.

Visual camera 448 can be a fixed (e.g., stationary) camera, or visual camera 448 can be a movable camera. Further, although a single visual camera 448 is illustrated in FIG. 4, embodiments of the present disclosure are not so limited. For example, in some embodiments UAV 408 can include a plurality (e.g., a cluster) of visual cameras, with each respective camera positioned at a different angle and/or pointing in a different direction.

FIG. 5 illustrates a route 562 for an unmanned aerial vehicle UAV 508 to take to travel (e.g., fly) to a location at a site 560 for continuous emission level monitoring and detection in accordance with one or more embodiments of the present disclosure. UAV 508 can be, for example, UAV 108 and/or 408 previously described in connection with FIGS. 1 and 4, respectively.

In the example illustrated in FIG. 5, site 560 is an industrial plant having a number of tanks (e.g., circular tanks), process plants, buildings, pipes, equipment, and other structures. However, embodiments of the present disclosure are not limited to a particular type of site, as previously described herein.

FIG. 5 illustrates a layout (e.g., a two-dimensional schematic representation) of site 560. The layout can be included (e.g., stored) in computing device 106 previously described in connection with FIG. 1.

As shown in FIG. 5, site 560 (e.g., the layout of site 560) includes a plurality of sensors 502-1, 502-2, 502-3, 502-4, 502-5, 502-6 located at different locations throughout the site (e.g., sensor 502-1 is located at a first location at the site, sensor 502-2 is located at a second location at the site, etc.). These sensors, which may collectively be referred to herein as sensors 502, can be analogous to sensors 102-1, 102-2, . . . , 102-N previously described in connection with FIG. 1. For instance, sensors 502 can include one or more gas detectors, and/or one or more imaging cameras, as previously described herein.

Sensors 502 can continuously capture emission levels at their respective locations at the site (e.g., sensor 502-1 can capture emission levels at the first location at the site, sensor 502-2 can capture emission levels at the second location at the site, etc.). These emission levels can include, for example, gas emission levels and/or water quality levels, as previously described herein.

In the example illustrated in FIG. 5, sensor 502-3 has captured an emission level that exceeds a pre-determined threshold. Accordingly, UAV 508 has been triggered (e.g., by computing device 106 previously described in connection with FIG. 1) to fly to the location of sensor 502-3 (e.g., to location 564) at site 560 to detect whether an emission level at location 564 exceeds the pre-determined threshold, in accordance with embodiments previously described herein.

As shown in FIG. 5, route 562 has been determined (e.g., by computing device 106) to be the route for UAV 508 to take to fly to location 564. Route 562 can be determined based on the layout of site 560 and the location of sensor 502-3. For instance, in the example illustrated in FIG. 5, route 562 is the shortest possible straight-line route for UAV 508 to take to location 564 in view of (e.g., to be able to avoid) the tanks, process plants, buildings, pipes, equipment, and other structures of plant 560. However, embodiments of the present disclosure are not limited to a shortest possible straight-line route. For instance, in some examples, the route (e.g., the shortest possible route) could include curves. Further, in some examples, the route may not be the shortest possible route in view of (e.g., to be able to avoid) certain areas and/or environmental conditions of the site along the route. Further, in some examples, the route may include elevation changes for UAV 508 along the route.

Route 562 can be sent UAV 508 (e.g., by computing device 106), as previously described herein. Using route 562, UAV 508 can fly (e.g., autonomously navigate) to location 564. Upon arriving at location 564, UAV 508 can detect whether an emission level at location 564 exceeds the pre-determined threshold (e.g., to verify whether a gas leak or other problem is occurring at location 564), and send a notification indicating the result of the detection, as previously described herein.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
capturing, by a plurality of sensors located at a site, emission levels at the site;
receiving, by a computing device, the captured emission levels from the plurality of sensors;
determining, by the computing device based on the emission levels received from the plurality of sensors, whether to trigger an unmanned aerial vehicle (UAV) to fly to a location at the site to detect whether an emission level at the location exceeds a pre-determined threshold; and
triggering, by the computing device responsive to a result of the determination, the UAV to fly to the location at the site to detect whether an emission level at the location exceeds the pre-determined threshold.

2. The method of claim 1, wherein the method includes:
flying, by the UAV, to the location at the site;
detecting, by the UAV upon arriving at the location at the site, whether an emission level at the location exceeds the pre-determined threshold; and
sending, by the UAV, a notification to the computing device that the emission level at the location exceeds the pre-determined threshold responsive to a result of the detection.

3. The method of claim 2, wherein the method includes triggering, by the computing device, an operation to reduce the emission level at the location responsive to receiving the notification that the emission level at the location exceeds the pre-determined threshold.

4. The method of claim 2, wherein the method includes determining, by the computing device based on the notification that that the emission level at the location exceeds the pre-determined threshold, whether to trigger the UAV to fly to an additional location at the site to detect whether an emission level at the additional location exceeds the pre-determined threshold.

5. The method of claim 1, wherein the method includes:
determining, by the computing device, safety pre-requisites for the UAV to fly to the location are met; and
triggering, by the computing device, the UAV to fly to the location at the site to detect whether an emission level at the location exceeds the pre-determined threshold responsive to determining the safety pre-requisites are met.

6. The method of claim 1, wherein the method includes:
receiving, by the computing device, notifications of operations occurring at the site; and
determining, by the computing device based on the operations occurring at the site, whether to trigger the UAV to fly to a location at the site to detect whether an emission level at the location exceeds the pre-determined threshold.

7. The method of claim 1, wherein the method includes determining, by the computing device, a route for the UAV to take to fly to the location at the site to detect whether an emission level at the location exceeds the pre-determined threshold.

8. The method of claim 7, wherein the method includes determining the route for the UAV to take to fly to the location at the site based on:
a layout of the site; and
the locations of the plurality of sensors at the site.

9. The method of claim 1, wherein the method includes:
continuously capturing, by the plurality of sensors, emission levels at the site;
continuously receiving, by the computing device, the captured emission levels from the plurality of sensors; and
continuously determining, by the computing device based on the emission levels received from the plurality of sensors, whether to trigger a UAV to fly to a location at the site to detect whether an emission level at the location exceeds a pre-determined threshold.

10. The method of claim 1, wherein the captured emission levels include gas emission levels.

11. A computing device, comprising:
a processor; and
a memory storing non-transitory machine-readable instructions to cause the processor to:
receive, from a sensor, an emission level captured at a location at a site;
determine that the captured emission level exceeds a pre-determined threshold; and
trigger, responsive to determining that the captured emission level exceeds the pre-determined threshold, an unmanned aerial vehicle (UAV) to fly to the location at the site to detect whether an emission level at the location exceeds the pre-determined threshold.

12. The computing device of claim 11, wherein the instructions cause the processor to receive, from the sensor, a location of the sensor at the site.

13. The computing device of claim 11, wherein the instructions cause the processor to receive, from the sensor:
a time the emission level was captured by the sensor; and
a type of the emission level captured by the sensor.

14. The computing device of claim 11, wherein the instructions cause the process to select a type of UAV to trigger to fly to the location at the site based on a location of the sensor at the site.

15. A system, comprising:
a plurality of sensors, wherein:
each respective one of the plurality of sensors is located at a different location at a site; and
each respective one of the plurality of sensors is configured to capture emission levels at its respective location at the site; and
a computing device configured to:
receive the captured emission levels from the plurality of sensors;
determine, based on the emission levels received from the plurality of sensors, whether to trigger an unmanned aerial vehicle (UAV) to fly to any of the different locations at the site to detect whether an emission level at that location exceeds a pre-determined threshold; and
trigger, responsive to a result of the determination, the UAV to fly to one of the different locations at the site to detect whether an emission level at that location exceeds the pre-determined threshold.

16. The system of claim 15, wherein the computing device is configured to trigger the UAV to fly to one of the different locations at the site responsive to the emission level received from the one of the plurality of sensors located at that location at the site exceeding the pre-determined threshold.

17. The system of claim 16, wherein the UAV is configured to:
fly to the one of the different locations at the site;
detect, upon arriving at the one of the different locations at the site, that an emission level at that location at the site exceeds the pre-determined threshold; and
send a notification to the computing device that the emission level at the one of the different locations at the site exceeds the pre-determined threshold responsive to detecting that the emission level at that location at the site exceeds the pre-determined threshold.

18. The system of claim 17, wherein the UAV includes a sensor configured to detect that the emission level at the one of the different locations at the site exceeds the pre-determined threshold.

19. The system of claim 15, wherein the computing device is configured to determine whether to trigger the UAV to fly to any of the different locations at the site to detect whether an emission level at that location exceeds the pre-determined threshold based on results of previous detections by the UAV of whether an emission level at that location exceeds the pre-determined threshold.

20. The system of claim 15, wherein the plurality of sensors include at least one of:
a gas detector;
a gas cloud imaging camera;
a thermal imaging camera; and
an infrared imaging camera.
